(19) United States
(12) Patent Application Publication
(10) Pub. No.: US 2013/0154353 A1
(43) Pub. Date: Jun. 20, 2013

(54) SPACE-DIVISION MULTIPLE POWER FEEDING AND COLLECTING APPARATUS

(71) Applicants: Nam Pyo Suh, Daejeon (KR); Sun Heung Chang, Daejeon (KR); Gyu Hyeong Cho, Daejeon (KR); Dong Ho Cho, Seoul (KR); Chun Taek Rim, Daejeon (KR); Jin Huh, Daejeon (KR); Sung Woo Lee, Gyeongsangnamdo (KR); Hyun Jae Kim, Daejeon (KR); Chang Byung Park, Daejeon (KR)

(72) Inventors: Nam Pyo Suh, Daejeon (KR); Sun Heung Chang, Daejeon (KR); Gyu Hyeong Cho, Daejeon (KR); Dong Ho Cho, Seoul (KR); Chun Taek Rim, Daejeon (KR); Jin Huh, Daejeon (KR); Sung Woo Lee, Gyeongsangnamdo (KR); Hyun Jae Kim, Daejeon (KR); Chang Byung Park, Daejeon (KR)

(73) Assignee: Korea Advanced Institute of Science and Technology, Daejeon (KR)

(21) Appl. No.: 13/701,739

(22) PCT Filed: Jun. 3, 2011
(86) PCT No.: PCT/KR2011/004070

§ 371 Date: Feb. 6, 2013

(30) Foreign Application Priority Data
Jun. 3, 2010 (KR) 10-2010-0052333

(51) Int. Cl. B60L 11/18; H02J 17/00

(52) U.S. Cl. CPC B60L 11/18; H02J 17/00
USPC 307/9.1; 307/104

(57) ABSTRACT

The present invention relates to a space-division multiple power feeding and collecting apparatus, and more specifically to a space-division multiple power feeding and collecting apparatus which is composed of multiple power feeding type lines using phase division, time division or frequency division and the like along a traveling direction of a moving body and receives electric power therethrough so as to feed the electric power to and to collect electric power from various moving bodies of a vehicle, and underwater moving body or a robot and the like in a non-contact manner. The present invention can obtain a constant output voltage through the minimization of a regular variation of an output voltage in the traveling direction of the moving body by applying the space-division multiple feeding method along the travelling direction of the moving body on an I-shaped feeding line, and increases an air gap by improving the mean output power to be transmitted to a secondary side and reducing the leakage flux generated between adjacent magnetic poles.

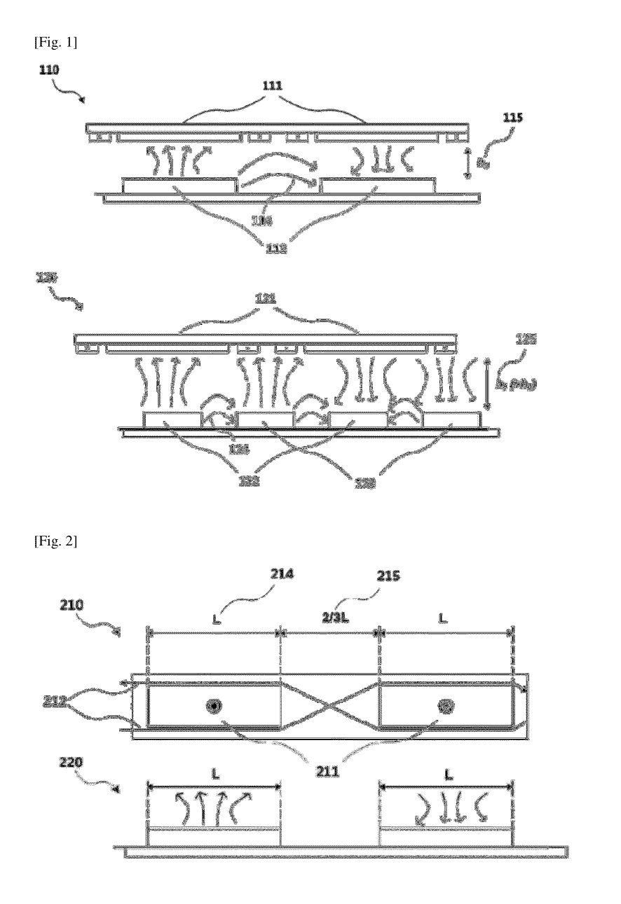

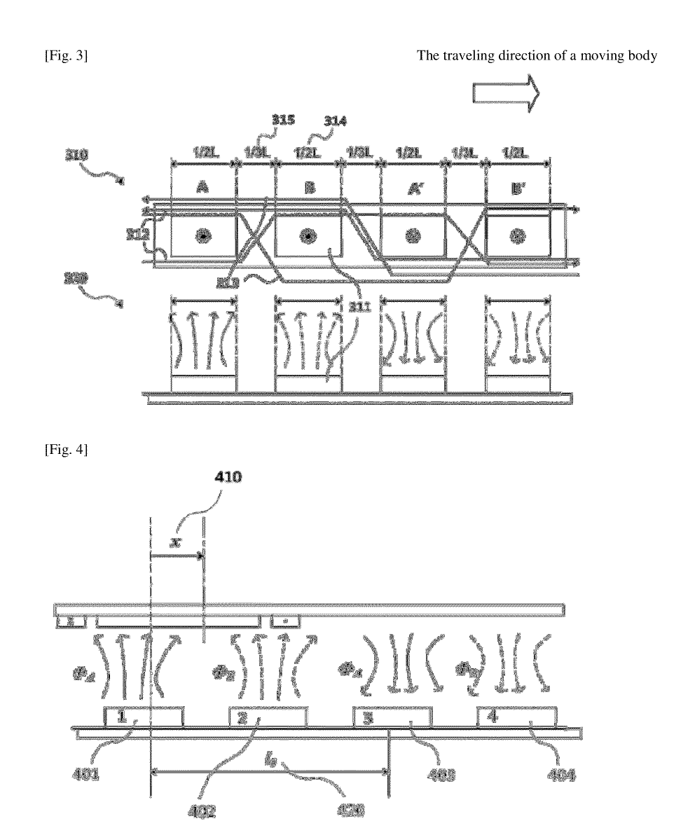

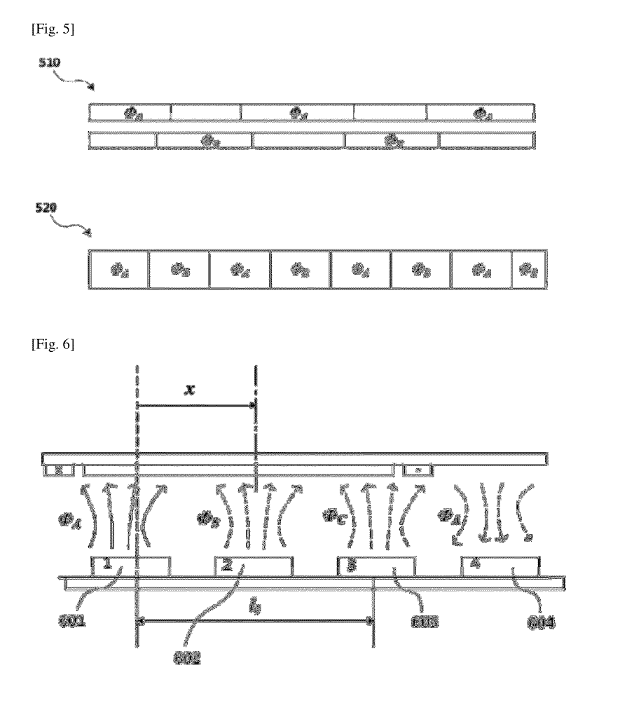

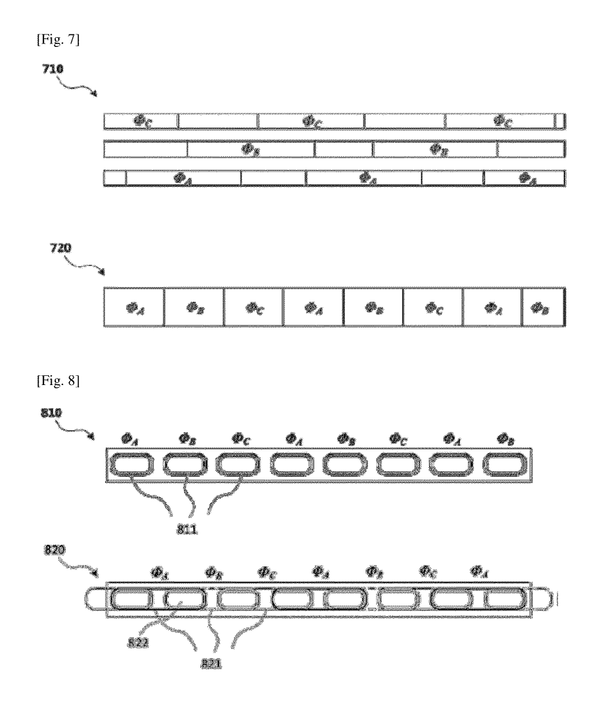

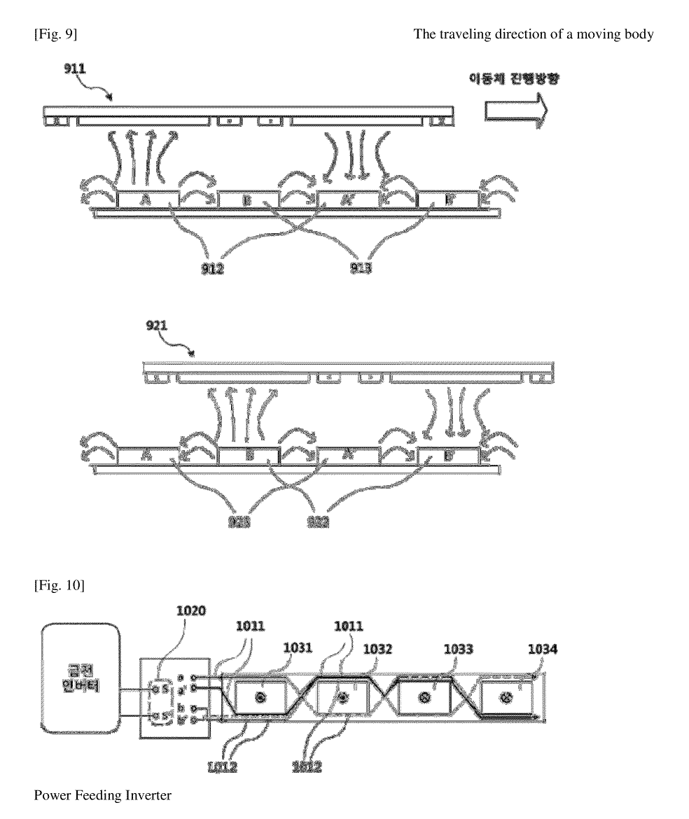

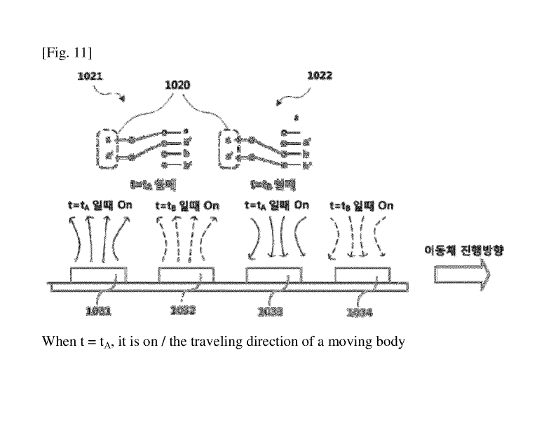

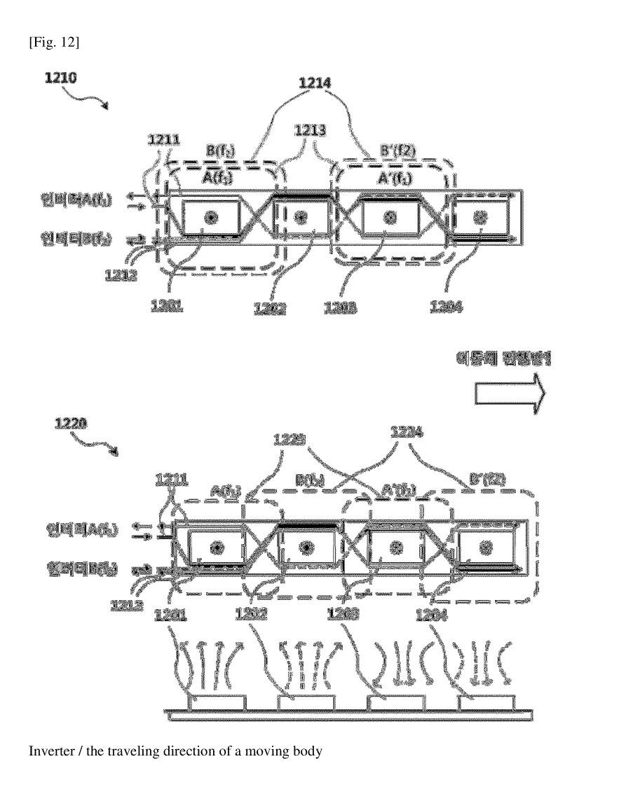

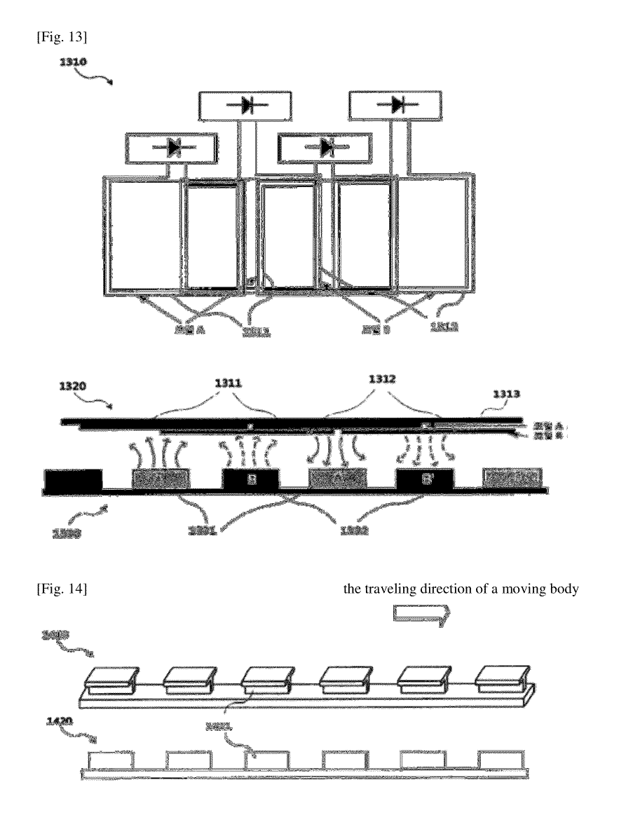

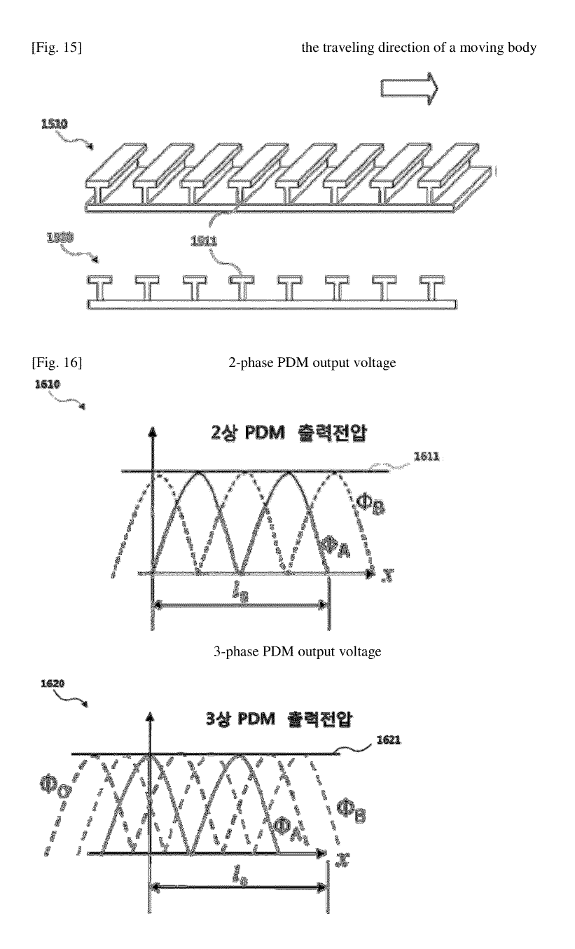

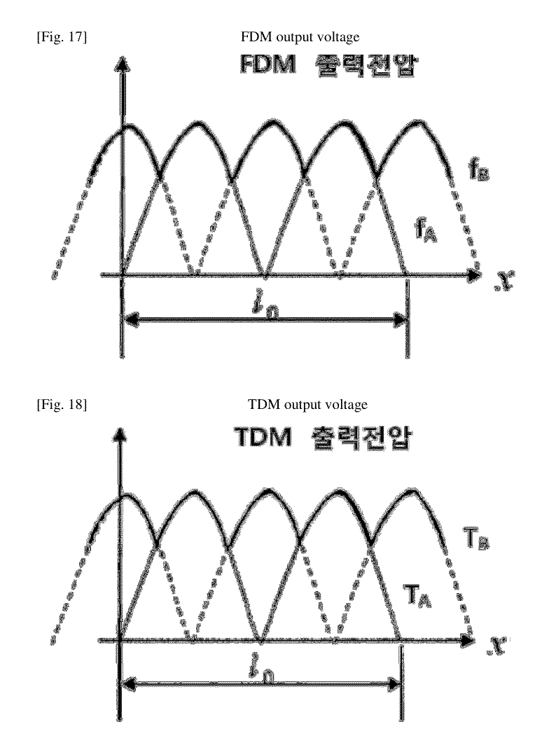

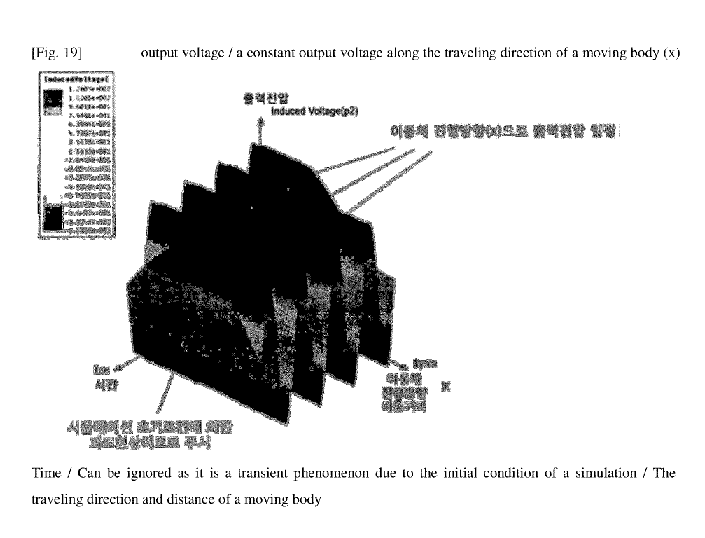

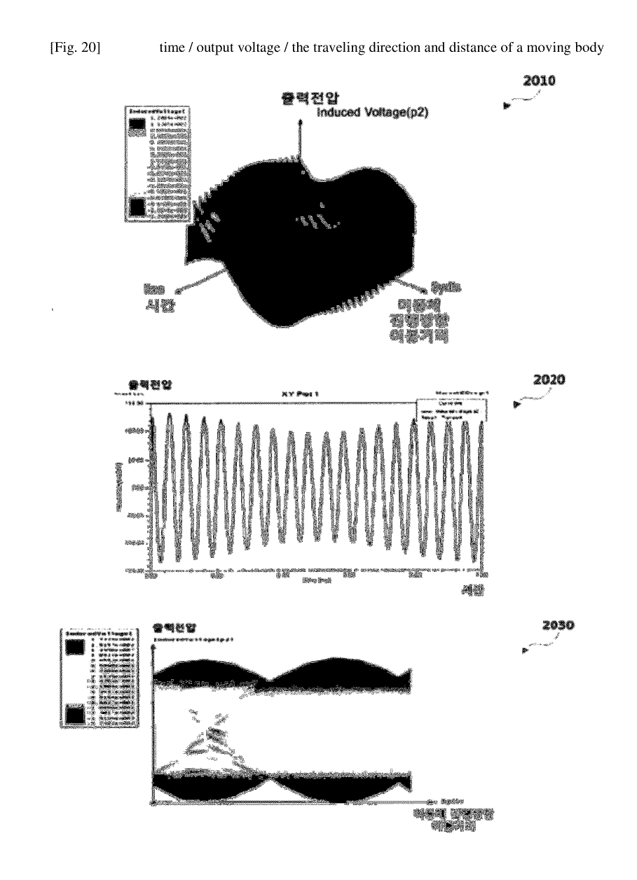

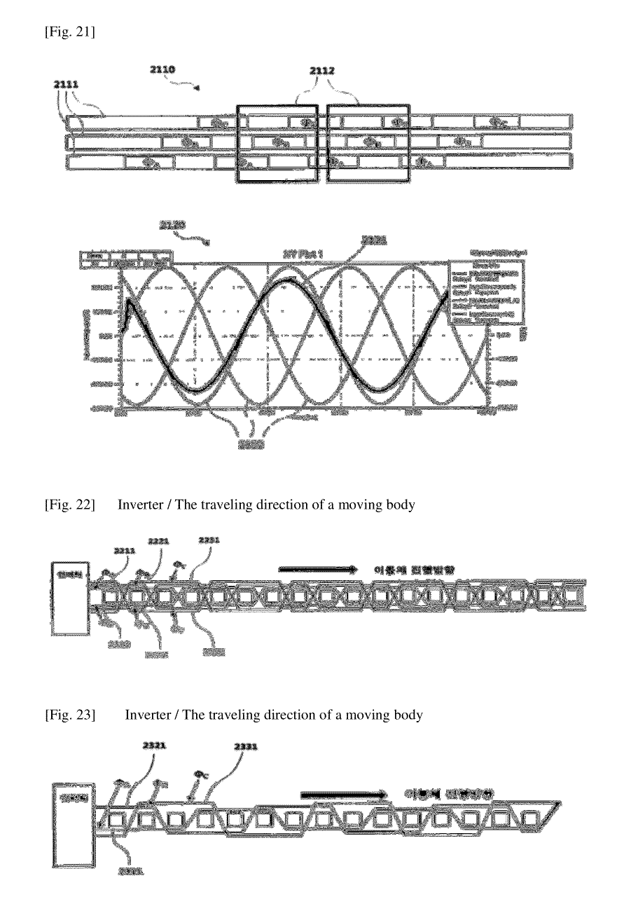

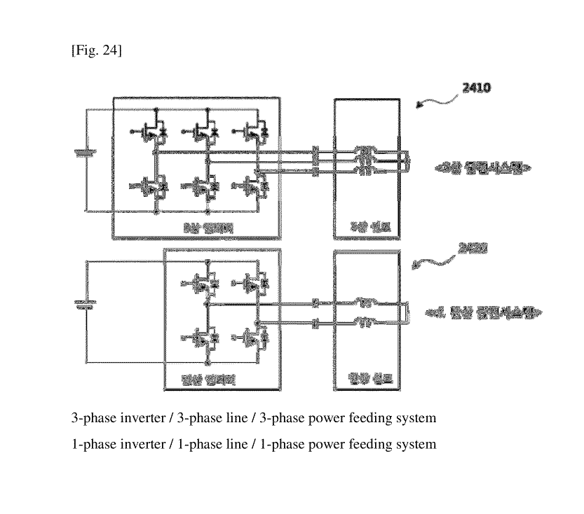

### TECHNICAL FIELD

The present invention relates to a space division multiple power feeding and collecting apparatus, and more specifically to a space division multiple power feeding and collecting apparatus which is composed of multiple power feeding type lines using phase division, time division or frequency division and the like along a traveling direction of a moving body and receives electric power therethrough so as to feed electric power to and to collect electric power from various moving bodies of a vehicle, an underwater moving body or a robot and the like in a non-contact manner.

### DESCRIPTION OF RELATED ART

An I-shaped feeding line for the existing online electric vehicle is very low in EMF (electromagnetic field) along with narrow feeding line structures. The word ‘I-shaped’ means the case where a cross section perpendicular to the road traveling direction of the magnetic pole of a power feeding appratus is I-shaped. But, upon actual application of this I-shaped feeding line, the mean output power is reduced to about half of the maximum electric power due to the output voltage characteristic of a secondary side in regular sinusoidal motion along a traveling direction of a vehicle. This reduction of mean output power has been indicated as the biggest problem to be solved.

Also, in order to increase the gap between power collecting apparatuses installed in a feeding road and an electric vehicle, or an air gap, the gap between adjacent magnetic poles should increase, in which case, however, the traveling direction width of a power collecting apparatus increases and the number of power collecting apparatuses mountable in a vehicle decreases.

### BRIEF SUMMARY OF THE INVENTION

### Technical Task

The present invention is invented to solve the abovementioned problem and can obtain a constant output voltage through the minimization of a regular variation of an output voltage in the traveling direction of the moving body by applying the space division multiple feeding method along the traveling direction of various moving bodies of a vehicle, an underwater moving body or a robot and the like on an I-shaped feeding line, and increases an air gap by improving the mean output power to be transmitted to a secondary side and reducing the leakage flux generated between adjacent magnetic poles.

### Means to Solve the Task

In order to obtain the abovementioned goal, a phase division multiple power feeding apparatus which feeds electric power to an electric vehicle using magnetic induction of the present invention comprises a power feeding core which has multiple magnetic poles arranged at regular intervals along the traveling direction of a moving body, a certain number (‘α’) of feeding line pairs in which along the traveling direction of a moving body, electric current flows countercurrent to the traveling direction of a moving body, and an inverter which controls electric current flowing in each of said feeding line pairs in which electric current of different phase flows. Each of feeding line pairs is arranged so that the N and S poles are alternately generated at every α out of a certain number of magnetic poles (‘magnetic pole group’), and the N-S pole pairs generated by each of feeding line pairs are not overlapped each other.

In each of α sequential magnetic pole groups along the traveling direction of a moving body, the N poles of different phases generated by each of the feeding line pairs from the 1^{st} to the αth feeding line pair can be sequentially generated, and in each of the next α sequent magnetic pole groups, the S poles of different phases generated by from the said 1^{st} to the said αth feeding line pair can be sequentially generated.

The magnetic pole groups composing said α N poles and said α S poles can be arranged in a line along the traveling direction of a moving body on a feeding line.

The magnetic pole groups composing said α N poles and said α S poles can be sequentially arranged along the traveling direction of a moving body on a parallel lines on a feeding line.

Said magnetic pole group(s) can be composed of one or a magnetic poles.

If the number of said feeding line pairs is 2, a desirable phase difference of electric current flowing in each of said feeding line pairs is 90 degree.

If the number of said feeding line pairs is 3, a desirable phase difference of electric current flowing in each of said feeding line pairs is 120 degree.

For said magnetic poles, the cross section perpendicular to the traveling direction of a moving body may be I-shaped and the width perpendicular to the traveling direction of a moving body may be less than half of the length of the traveling direction of a moving body.

For said magnetic poles, the cross section viewed from the road may be I-shaped and the width perpendicular to the traveling direction of a moving body may be greater than twice of the length of the traveling direction of a moving body.

According to another aspect of the present invention, a phase division multiple power feeding apparatus which feeds electric power to an electric vehicle using magnetic induction of the present invention comprises a power feeding core which have multiple magnetic poles arranged at regular intervals along the traveling direction of a moving body, three feeding lines in which along the traveling direction of a moving body, electric current of phase difference of 120 degree flows, and an inverter which controls electric current flowing in each of said feeding lines. Each of feeding lines is arranged so that the N and S poles are alternately generated at every 3 out of a certain number of magnetic poles (‘magnetic pole group’), and the N-S pole pairs generated by each of feeding lines are not overlapped each other.

According to another aspect of the present invention, a time division multiple power feeding apparatus which feeds electric power to an electric vehicle using magnetic induction of the present invention comprises a power feeding core which has multiple magnetic poles arranged at regular intervals along the traveling direction of a moving body, a certain number (‘b’) of feeding line pairs in which along the traveling direction of a moving body, electric current flows countercurrent to the traveling direction of a moving body, and an inverter which controls electric current flowing in each of said feeding line pairs in which electric current flows in different time zones. Each of feeding line pairs is arranged so that the N and S poles are alternately generated at every b magnetic poles.

Said inverter can control the switch corresponding to each feeding line pair so that the N and S poles are generated at the magnetic pole corresponding to the location of a traveling vehicle.

Said magnetic poles can be arranged in a line on the feeding line along the traveling direction of a moving body.

Said magnetic poles are arranged on the feeding line along b rows parallel to the traveling direction of a moving body (‘magnetic pole row’), and the magnetic pole row in which said N and S poles are generated may move sequentially from the 1^{st} to the bth magnetic pole row along the traveling of a vehicle.

For said magnetic poles, the cross section perpendicular to the traveling direction of a moving body may be I-shaped and the width perpendicular to the traveling direction of a moving body may be less than half of the length of the traveling direction of a moving body.

For said magnetic poles, the cross section viewed from the road may be I-shaped and the width perpendicular to the traveling direction of a moving body may be more than twice of the length of the traveling direction of a moving body.

According to another aspect of the present invention, a frequency division multiple power feeding apparatus which feeds electric power to an electric vehicle using magnetic induction of the present invention comprises a power feeding core which have multiple magnetic poles arranged at regular intervals along the traveling direction of a moving body, a certain number (‘c’) of feeding line pairs in which along the traveling direction of a moving body, electric current flows countercurrent to the traveling direction of a moving body, and an inverter which controls electric current flowing in each of said feeding line pairs in which electric current of different frequency flows. Each of feeding line pairs is arranged so that the N and S poles are alternately generated at every c magnetic pole and the N-S pole pairs generated by each feeding line pairs are not overlapped each other.

In each of c sequential magnetic poles along the traveling direction of a moving body, the N poles of different frequencies generated by each of feeding line pairs from the 1^{st} to the cth feeding line pair can be sequentially generated, and in each of the next c sequent magnetic poles, the S poles of different frequencies generated by each of feeding line pairs from the 1^{st} to the cth feeding line pair can be sequentially generated.

The magnetic poles composing said c N poles and said c S poles can be arranged in a line along the traveling direction of a moving body.

The magnetic poles composing said c N poles and said S poles can be sequentially arranged along the traveling direction of a moving body on c parallel lines on a feeding line.

For said magnetic poles, the cross section perpendicular to the traveling direction of a moving body may be I-shaped and the width perpendicular to the traveling direction of a moving body may be less than half of the length of the traveling direction of a moving body.

For said magnetic poles, the cross section viewed from the road may be I-shaped and the width perpendicular to the traveling direction of a moving body may be more than twice of the length of the traveling direction of a moving body.

According to another aspect of the present invention, a power collecting apparatus which collects electric power from a space division multiple power feeding apparatus which feeds electric power to a moving body using magnetic induction of the present invention comprises a power collecting core which is installed at the bottom of a moving body with space from the power feeding apparatus and a power collecting coil which is wound around said power collecting core so that electric current induced by the power feeding apparatus may flow, and the power collecting coil comprises more than two pairs so as to multiple collect electric power.

Said power feeding apparatus can generate more than two magnetic fields of different phases using phase division multiplexing, and in each of the pairs of said power collecting coil, electric current of different phase can be induced by said magnetic fields.

Said power feeding apparatus can generate more than two magnetic fields of different frequencies using frequency division multiplexing, and in each of the pairs of said power collecting coil, electric current of different frequency can be induced by said magnetic field.

### Effect of the Invention

The present invention can obtain a constant output voltage through the minimization of a regular variation of an output voltage in the traveling direction of a moving body by applying the space division multiple feeding method along the traveling direction of various moving bodies of a vehicle, an underwater moving body or a robot and the like on an I-shaped feeding line, and increases an air gap by improving the mean output power to be transmitted to a secondary side and reducing the leakage flux generated between adjacent magnetic poles.

### BRIEF DESCRIPTION OF THE SEVERAL VIEW OF THE DRAWING

Drawing 1 shows the side view of the existing I-shaped feeding and collecting structure and of the feeding and collecting structure of the present invention.

Drawing 2 shows the top view and the side view of the existing I-shaped feeding and collecting apparatus.

Drawing 3 shows the top view and the side view of the space division multiple power feeding and collecting apparatus of the present invention.

Drawing 4 shows the side view of 2-phase multiple power feeding and collecting structure of the present invention.

Drawing 5 shows the top view of 2-phase multiple feeding line of the present invention.

Drawing 6 shows the side view of 3-phase multiple feeding line of the present invention.

Drawing 7 shows the top view of 3-phase multiple feeding line of the present invention.

Drawing 8 shows the method to configure multiple poles on a mono rail feeding line.

Drawing 9 shows the side views of the time division multiple power feeding and collecting structure of the present invention.

Drawing 10 shows the top view of the time division multiple power feeding and collecting apparatus of the present invention.

Drawing 11 shows an embodiment of switching method according to time in the time division multiple power feeding and collecting apparatus of the present invention.

Drawing 12 shows the top view and the side view of the frequency division multiple power feeding and collecting structure of the present invention.

Drawing 13 shows an embodiment of the case where multi-pickup power collecting is used in the I-shaped space division multiple feeding structure of the present invention.

Drawing 14 shows an I-shaped feeding core structure in which the cross section of a magnetic pole perpendicular to the traveling direction of a moving body is I-shaped.

Drawing 15 shows an I-shaped feeding core structure in which the cross section of a magnetic pole viewed from the road is I-shaped.

Drawing 16 shows an output voltage of PDM (phase division multiplex) feeding line.

Drawing 17 shows the embodiment of an output voltage of FDM (frequency division multiplex) feeding line.

Drawing 18 shows the embodiment of an output voltage of TDM (time division multiplex) feeding line.

Drawing 19 shows the result of a simulation of an output voltage of PDM feeding line in three dimensions by the traveling direction, traveling distance (x) and elapsed time of a moving body.

Drawing 20 shows the result of a simulation of an output voltage of FDM feeding line.

Drawing 21 shows an embodiment of voltage induced in a power collecting coil by application of a 3-phase PDM line structure.

Drawing 22 shows an embodiment of the case of two-way type feeding line corresponding to each phase of a 3-phase feeding line.

Drawing 23 shows an embodiment of the case of one-way type feeding line corresponding to each phase of a 3-phase feeding line.

Drawing 24 shows an embodiment of a 3-phase feeding inverter circuit and a 1-phase feeding inverter circuit in PDM feeding apparatus.

### THE IDEAL FORM FOR EMBODIMENT OF THE INVENTION

From now on, a desirable embodiment of the present invention will be described in detail on reference to the attached drawings. Prior to this, the terms or words used in the present specifications and claims should not be limited to usual or dictionary meanings but be interpreted in such meanings and concepts that correspond to the technical idea of the present invention based on a principle that the inventor can properly define the concepts of the terms to explain his invention in the best way. Therefore, the configurations illustrated in the embodiments and drawings of the present specifications are merely the most desirable embodiments of the present invention and do not represent all the technical ideas of the present invention, and it should be understood that there could be various equal things and varied examples which can replace such configurations at the time of the present application.

Drawing 1 shows the side view of the existing I-shaped power feeding and collecting structure and of the power feeding and collecting structure of the present invention.

The existing I-shaped power feeding and collecting structure (110) can obtain the maximum output voltage only after a pair of power collecting pick-up (111) and two magnetic poles (112) on a feeding line form in line exactly. The space division multiple feeding line of the present invention (120) has multiple feeding lines (122, 123) under a pair of power collecting pick-up (121), which bring about multiple N and S poles. Also, because the leakage flux between adjacent magnetic poles (115) is smaller than the case of the existing structure (114), a much bigger air gap (125) than the case of the existing structure (115) is available.

Drawing 2 shows the top view (210) and the side view (220) of the existing I-shaped feeding and collecting apparatus.

It is a structure in which the N and S poles are alternately generated in adjacent magnetic poles (211) by a pair of feeding lines (212) in which countercurrents flow. That is, a pair of N and S poles exists under a pair of collecting pick-up (111) attached to a vehicle. The length of a magnetic pole (214) and the interval between magnetic poles (215) are relatively long, thereby the leakage flux increases and the mean output power decreases because the variation of sinusoidal output voltage is relatively large.

Drawing 3 shows the top view (310) and the side view (320) of the I-shaped space division multiple power feeding and collecting apparatus of the present invention.

Power feeding and collecting apparatus described on reference to this drawing and all the subsequent drawings can be applied to not only vehicles but also various moving bodies such as underwater moving bodies, ground moving bodies, robots and the like which are supplied with power in a non-contact manner. From now on, such various objects as vehicles, underwater moving bodies, ground moving bodies, robots and the like which are supplied with power in a non-contact manner are commonly called a ‘moving body’.

There are the 1^{st} feeding line pair (312) and the 2^{nd} feeding line pair (313), each of which comprises a pair of feeding lines in which countercurrents flow. By the currents flowing in the 1^{st} feeding line pair (312), the N and S poles are alternately generated in the magnetic poles A and A′, and by the currents flowing in the 2^{nd} feeding line pair (313), the N and S poles are alternately generated in the magnetic poles B and B′. The length (314) of a magnetic pole (311) and the interval (315) between magnetic poles are shorter than the case of Drawing 2, thereby the leakage flux decreases and the variation of sinusoidal output voltage along the traveling direction of a moving body becomes smaller, which increases the mean output power.

Drawing 4 shows the side view of 2-phase multiple power feeding and collecting structure of the present invention.

It is a case where electric currents of difference phases flow in the 1^{st} feeding line pair (312) and the 2^{nd} feeding line pair (313) which are explained on reference to Drawing 3. That is, by the currents of Φ_{A} phase flowing in the 1^{st} feeding line pair (312), the N and S poles are generated in the magnetic poles No. 1 (401) and No. 3 (403), and by the currents of Φ_{B} phase flowing in the 2^{nd} feeding line pair (313), the N and S poles are generated in the magnetic poles No. 2 (402) and No. 4 (404). That is, for this drawing, the magnetic fields by the currents of Φ_{A}, Φ_{B}, Φ_{A}, and Φ_{B} phase are generated sequentially in the magnetic poles No. 1 through No. 4, and the N (Φ_{A}), N (Φ_{B}), S (Φ_{A}), and S (Φ_{B}) poles are generated sequentially.

Meanwhile, in this drawing and the subsequent drawings, ‘x’ (410) indicates the traveling distance of a moving body and ‘10’ (420) indicates the distance between the N and S poles generated by the currents of Φ_{A} phase flowing in the 1^{st} feeding line pair (312).

Drawing 5 shows the top view of 2-phase multiple feeding line of the present invention.

As abovementioned in Drawing 4, the N (Φ_{A}), N (Φ_{B}), S (Φ_{A}), and S (Φ_{B}) poles are generated sequentially in the sequent magnetic poles on a feeding line, and they might be arranged either in the dual rail (510) in which the magnetic poles are arranged in two rows or in the mono rail (520) in which the magnetic poles are arranged in one row.

Drawing 6 shows the side view of 3-phase multiple feeding line of the present invention.

This drawing shows a case where currents of different phases flow in the 1^{st} feeding line pair (312), the 2^{nd} feeding line pair (313) and the 3^{rd} feeding line pair (not shown). That is, by the currents of Φ_{A} phase flowing in the 1^{st} feeding line pair (312), the N and S poles are generated in the magnetic poles No. 1 (601) through No. 4 (604), and by the currents of Φ_{B} phase flowing in the 2^{nd} feeding line pair (313), the N and S poles are generated in the magnetic poles No. 2 (602) through No. 5 (not shown), and by the currents of Φ_{C} phase flowing in the 3^{rd} feeding line pair (not shown), the N and S poles are generated in the magnetic poles No. 3 (603) through No. 6 (not shown). That is, for this drawing, the magnetic fields by the currents of Φ_{A}, Φ_{B}, Φ_{C}, Φ_{A}, Φ_{B}, and Φ_{C} phase are generated sequentially in the magnetic poles No. 1 through No. 6, and the N (Φ_{A}) N (Φ_{B}), N (Φ_{C}), S (Φ_{A}), S (Φ_{B}) and S (Φ_{C}) poles are generated sequentially.

Drawing 7 shows the top view of 3-phase multiple feeding line of the present invention.

As abovementioned in Drawing 6, the N (φ_{A}), N (Φ_{B}), N (Φ_{C}), S (Φ_{A}), S (Φ_{B}) and S (Φ_{C}) poles are generated sequentially in the sequent magnetic poles on a feeding line, and they might be arranged either in the triple rail (710) in which the magnetic poles are arranged in three rows or in the mono rail (720) in which the magnetic poles are arranged in one row.

Drawing 8 shows the method to configure multiple magnetic poles on a mono rail feeding line.

In a three-phase mono rail, the single magnetic pole (811) is a way to form one phase using a separate magnetic pole and the dual magnetic pole (821) is a way to form one phase using a pair of two magnetic poles (‘magnetic pole group’) (820). For the dual magnetic pole, a series of magnetic pole group can be formed in the type of sharing one magnetic pole (822). For the two-phase mono rail, a magnetic pole group can be formed by one or two magnetic poles, thereby one phase can be formed, respectively, and for the three-phase mono rail, a magnetic pole group can be formed by one, two or three magnetic poles, thereby one phase can be formed, respectively.

Drawing 9 shows the side views of the time division multiple power feeding and collecting structure of the present invention.

The time division multiple feeding line is same as the two-phase division multiple feeding line in shape and run by turning on or off each of the feeding lines in time. That is, it detects the locations (911, 921) of a power collecting apparatus attached to a moving body and feeds currents to the feeding lines in necessary locations and cuts off currents from the rest feeding lines. By doing this, it can improve the variation of an output voltage regularly generated along the traveling direction of a moving body and make the output voltage even. In order to effectively apply this method, a moving body on a feeding line should be located. Each of the feeding lines can run by different inverters or one inverter and one switch.

Drawing 10 shows the top view of the time division multiple power feeding and collecting apparatus of the present invention.

The 1^{st} feeding line pair (1011) and the 2^{nd} feeding line pair (1012) are run by the switch (1020) separately; if the 1^{st} feeding line pair (1011) is run, the N and S poles are generated in the magnetic poles No. 1 (1031) and No. 3 (1033), and if the 2^{nd} feeding line pair (1012) is run, the N and S poles are generated in the magnetic poles No. 2 (1032) and No. 4 (1034).

Drawing 11 shows an embodiment of switching method according to time in the time division multiple power feeding apparatus of Drawing 10.

If a power collecting apparatus of a moving body as shown in Drawing 9 is on the 1^{st} position (911) (t=t_{A}), the switch (1020) of Drawing 11 is connected to the a and a′ (1021) and the 1^{st} feeding line pair (1011) is nm, thereby the N and S poles are generated in the magnetic poles No. 1 (1031) and No. 3 (1033). If a moving body is moved and the power collecting apparatus is on the 2^{nd} position (921) (t=t_{B}), the switch (1020) of Drawing 11 is connected to the b and b′ (1022) and the 2^{nd} feeding line pair (1012) is run, thereby the N and S poles are generated in the magnetic poles No. 2 (1032) and No. 4 (1034).

Drawing 12 shows the top view and the side view of the frequency division multiple power feeding and collecting structure of the present invention.

The frequency division multiple power feeding line is same as the two-phase division multiple feeding line in shape and makes a power collecting apparatus resonate for the frequency of currents injected to each of the feeding lines. That is, in the 1^{st} feeding line pair (1211), currents of frequency f₁ flows and generates the magnetic field by the f₁ in the magnetic poles No. 1 (1201) and No. 3 (1203), and in the 2^{nd} feeding line pair (1212), currents of frequency f₂ flows and generates the magnetic field by the f₂ in the magnetic poles No. 2 (1202) and No. 4 (1204).

A power collecting pick-up in frequency division operation uses two pairs of coils (1213, 1214) tuned for each frequency, and the power collecting coils are arranged in the power collecting pick-up as shown in the top drawing (1210). The power collecting coils (1223, 1224) illustrated in the bottom drawing show for which frequency the power collecting coils are tuned to operate (output) on each of the power collecting pick-up positions. That is, on the 1^{st} position, the power collecting coils A and A′ (1223) tuned for the frequency f₁ operate and on the moved 2^{nd} position, the power collecting coils B and B′ (1224) tuned for the frequency f₂ operate.

By doing this, multiple power collecting paths by frequency division are formed in one feeding line and more than twice power delivery is possible. In particular, different frequencies in a power collecting apparatus bring about different points of resonance, which lead to an easy separation. In order to apply this method, two inverters should be used but electric power is shared, which may cause the cost of a power feeding inverter to be increased less than twice of the existing dual power feeding inverter.

Drawing 13 shows an embodiment of the case where multi-pickup power collecting (1320) is used in the I-shaped space division multiple feeding structure of the present invention.

The top drawing (1310) shows the top view of power collecting coils (1311, 1312) of a multi-pickup power collecting apparatus, and the middle drawing (1320) shows the side view of the above-mentioned power collecting coils (1311, 1312) and a power collecting core (1313), and the below drawing (1330) shows a power feeding apparatus.

In this case, a multiple feeding method of the power feeding apparatus (1330) can be either phase division multiplex (PDM) or frequency division multiplex (FDM). That is, the N and S poles of the same phase can be generated in the magnetic poles A and A′ (1331) and the N and S poles of the magnetic field with 90-degree phase difference from said magnetic poles A and A′ can be generated in the magnetic poles B and B′ (1332). Or, the N and S poles of the same frequency can be generated in the magnetic poles A and A′ (1331) and the N and S poles of the magnetic field with different frequency in the magnetic poles B and B′ (1332).

Multiple power collecting comprises two pairs of power collecting coils (1310, 1320) which are arranged in the same way as power feeding (for PDM, they are aligned in the center of the magnetic pole of each phase), as shown in the drawing. The flux generated from power feeding (for 2-phase) can be expressed in sine and cosine, and a constant output voltage can be obtained always from wherever the power collecting coil is positioned, for spatial dependence of the flux disappears. Therefore if the coils are arranged as shown in the drawing, the same voltage can be obtained from each of them and double delivery of output power is possible.

Drawing 14 shows an I-shaped feeding core structure in which the cross section of a magnetic pole (1411) perpendicular to the traveling direction of a moving body is I-shaped.

In this drawing, the oblique top view (1410) and the side view (1420) are illustrated.

A power feeding core structure in this shape can be applied to any case of multiple power feeding line by phase division, time division or frequency division.

Drawing 15 shows an I-shaped feeding core structure in which the cross section of a magnetic pole (1511) viewed from the road is I-shaped.

In this drawing, the oblique top view (1510) and the side view (1520) are illustrated.

A power feeding core structure in this shape can be applied to any case of multiple power feeding line by phase division, time division or frequency division.

Drawing 16 shows an output voltage of PDM (phase division multiplex) feeding line.

As abovementioned on reference to Drawing 4, ‘x’ indicates the traveling distance of a moving body and ‘I₀’ indicates the distance between the magnetic poles No. 1 and No. 3, that is, the distance between the N and S poles which are generated by currents of Φ_{A} phase flowing in the 1^{st} feeding line pair.

For 2-phase PDM (1610), a formula to get the final output voltage is as follows:

$$\begin{matrix}{V}_{o} = \vert j {ω}_{s} ( {φ}_{A} + {φ}_{B} ) {N}_{2} \vert ∵ {v}_{o} ( t ) = N \frac{d φ ( t )}{d t} \\ = {ω}_{s} {N}_{2} \vert ( {φ}_{o} {e}^{j 0} ) cos ( 2 π x / {l}_{0} ) + ( {φ}_{o} {e}^{j \frac{π}{2}} ) sin ( 2 π x / {l}_{0} ) \vert \\ = {ω}_{s} {N}_{2} {φ}_{o} \vert cos ( 2 π x / {l}_{0} ) + j sin ( 2 π x / {l}_{o} ) \vert \\ = {ω}_{s} {N}_{2} {φ}_{o} \sqrt{{cos}^{2} ( 2 π x / {l}_{0} ) + {sin}^{2} ( 2 π x / {l}_{o} )} \\ = {ω}_{s} {N}_{2} {φ}_{o}\end{matrix}$$

For 3-phase PDM (1620), a formula to get the final output voltage is as follows:

$$\begin{matrix}{V}_{o} ( x ) = \vert j {ω}_{s} ( {φ}_{A} + {φ}_{B} + {φ}_{C} ) {N}_{2} \vert , ∵ {v}_{o} ( t ) = N \frac{d φ ( t )}{d t} \\ = {ω}_{s} {N}_{2} \vert {{\sum }_{k = 0}}^{2} {φ}_{o} cos ( \frac{2 π x}{{l}_{0}} + \frac{2 π}{3} k ) {e}^{j \frac{2 π}{3} k} \vert , ∵ {φ}_{k} ( t ) = {φ}_{k} ( x ) Re \{ {e}^{jω , t + j \frac{2 π}{3} k} \} \\ = {ω}_{s} {N}_{2} {φ}_{o} \vert {{\sum }_{k = 0}}^{2} \frac{{e}^{j \frac{2 π x}{{l}_{0}} + j \frac{2 π}{3} k} + {e}^{- j \frac{2 π x}{{l}_{0}} - j \frac{2 π}{3} k}}{2} {e}^{j \frac{2 π}{3} k} \vert \\ = \frac{{ω}_{s} {N}_{2} {φ}_{o}}{2} \vert {{\sum }_{k = 0}}^{2} \{ {e}^{j \frac{2 π x}{{l}_{0}} + j \frac{4 π}{3} k} + {e}^{- j \frac{2 π x}{{l}_{0}}} \} \vert \\ = \frac{{ω}_{s} {N}_{2} {φ}_{o}}{2} \vert {e}^{j \frac{2 π x}{{l}_{0}}} {{\sum }_{k = 0}}^{2} \{ {e}^{j \frac{4 π}{3} k} \} + {{\sum }_{k = 0}}^{2} \{ {e}^{- j \frac{2 π x}{{l}_{0}} k} \} \vert \\ = \frac{{ω}_{s} {N}_{2} {φ}_{o}}{2} \vert 0 + 3 {e}^{- j \frac{2 π x}{{l}_{0}}} \vert \\ = \frac{3 {ω}_{s} {N}_{2} {φ}_{o}}{2} ∵ \frac{\partial {V}_{o} ( x )}{\partial x} = 0\end{matrix}$$

That is, both 2-phase and 3-phase PDM, the final output voltage V₀ (x) is a fixed value regardless of x the traveling distance of a moving body and expressed as a linear graph (1611, 1621) as shown in the drawing.

Drawing 17 shows the embodiment of an output voltage of FDM (frequency division multiplex) feeding line.

Drawing 18 shows the embodiment of an output voltage of TDM (time division multiplex) feeding line.

As explained on reference to Drawing 9 through Drawing 11, TDM is a way to turn on a power feeding line for a pick-up to be supplied with electric power to the maximum by the temporal analysis of the location of the pick-up. Therefore, if the T_{A} is turned on, the T_{B} line is turned off, and if the pick-up is moved to another location, the T_{A} and T_{B} are reversed.

Drawing 19 shows the result of a simulation of an output voltage of phase division multiplex feeding line in three dimensions by the traveling direction, traveling distance (x) and elapsed time of a moving body.

A constant output voltage according to the traveling distance of a moving body (x) is observed.

Drawing 20 shows the result of a simulation of an output voltage of frequency division multiplex feeding line.

An output voltage is shown in three dimensions by the traveling distance (x) of a moving body along the traveling direction and elapsed time in one drawing (2010), by elapsed time in another drawing (2020), and by the traveling distance of a moving body along the traveling direction in yet another drawing (2030).

Drawing 21 shows an embodiment of voltage induced in a power collecting coil by application of a 3-phase PDM line structure.

The top drawing (2110) shows a 3-phase PDM line consisting of three feeding lines of phase difference of 120 degree which is arranged in the traveling direction of a moving body and a pair of power collecting coils (2112) is arranged in the center of the N and S poles. The bottom drawing (2120) is a graph which shows a voltage induced in a power collecting coil by application of the above structure. A think line indicates the induced voltage in one power collecting coil, and if two power collecting coils are combined in series, the induced voltage becomes 556V. The rest 3 signals (2122) indicate the currents (200 A rms of currents which have a 120-degree phase difference) entered the feeding line. The result of a simulation like this shows that even if a 3-phase PDM line is designed for triple rail type, not to mention of mono rail type, we can get a constant output voltage regardless of the distance (sinusoidal in time).

Drawing 22 shows an embodiment of the case of two-way type feeding line corresponding to each phase of a 3-phase feeding line.

Each phase has two power feeding lines. That is, the feeding lines of Φ_{A} phase (2211, 2212), the feeding lines of Φ_{B} phase (2221, 2222), and the feeding lines of Φ_{C} phase (2231, 2232) are illustrated. The feeding lines of each phase are configured so as to cross each other in a unit of three magnetic poles, and the phase difference is 120 degree. It is configured so as to be wound at 2π/3, or two magnetic poles.

Drawing 23 shows an embodiment of the case of one-way type feeding line corresponding to each phase of a 3-phase feeding line.

Each phase has one power feeding line. That is, the feeding line of Φ_{A} phase (2311), the feeding line of Φ_{B} phase (2321) and the feeding line of Φ_{C} phase (2331) are illustrated. The feeding line of each phase is configured so as to cross each other in a unit of three magnetic poles. Three 3-phase feeding lines starting from an inverter are bound together at the end of the line as shown in the drawing.

Drawing 24 shows an embodiment of a 3-phase feeding inverter circuit (2410) and a 1-phase feeding inverter circuit (2420) in phase division multiplex power feeding apparatus.

What is claimed is:

1. A phase division multiple power feeding apparatus that feeds electric power to a moving body using magnetic induction which comprises
A power feeding core which has multiple magnetic poles arranged at regular intervals along the traveling direction of a moving body;
A certain number (‘α’) of feeding line pairs in which along the traveling direction of a moving body, electric currents flow countercurrent to the traveling direction of a moving body, and
An inverter which controls electric currents flowing in each of said feeding line pairs;
In each of feeding line pairs, electric currents of different phase flow, and each feeding line pair is arranged so that the N and S poles are alternately generated at every α out of a certain number of magnetic poles (‘magnetic pole group’), and the N-S pole pairs generated by each feeding line pair are not overlapped each other.

2. A phase division multiple power feeding apparatus as claim 1, wherein in each of α sequential magnetic pole groups along the traveling direction of a moving body the N poles of different phases generated by each of the feeding line pairs from the 1^{st} feeding line pair to the αth feeding line pair can be sequentially generated, and
In each of the next α sequent magnetic pole groups, the S poles of different phases generated by each of the feeding line pairs from the 1^{st} feeding line pair to the αth feeding line pair can be sequentially generated.

3. A phase division multiple power feeding apparatus as claim 2, wherein the pole groups composing said α N poles and said α S poles can be arranged in a line along the traveling direction of a moving body on a feeding line.

4. A phase division multiple power feeding apparatus as claim 2, wherein the magnetic pole groups composing said α N poles and said α S poles can be sequentially arranged along the traveling direction of a moving body on α parallel lines on a feeding line.

5. A phase division multiple power feeding apparatus as claim 1, wherein said magnetic pole groups can be composed of one magnetic pole or α magnetic poles.

6. A phase division multiple power feeding apparatus as claim 1, wherein if the number of said feeding line pairs is 2, a desirable phase difference of electric currents flowing in each of said feeding line pairs is 90 degree.

7. A phase division multiple power feeding apparatus as claim 1, wherein if the number of said feeding line pairs is 3, a desirable phase difference of electric current flowing in each of said feeding line pairs is 120 degree.

8. A phase division multiple power feeding apparatus as claim 1, wherein for said magnetic poles, the cross section perpendicular to the traveling direction of a moving body may be I-shaped and the width perpendicular to the traveling direction of a moving body may be less than half of the length of the traveling direction of a moving body.

9. A phase division multiple power feeding apparatus as claim 1, wherein for said magnetic poles, the cross section viewed from the road may be I-shaped and the width perpendicular to the traveling direction of a moving body may be greater than twice of the length of the traveling direction of a moving body.

10. A phase division multiple power feeding apparatus that feeds electric power to a moving body using magnetic induction which comprises
A power feeding core which have multiple magnetic poles arranged at regular intervals along the traveling direction of a moving body,
Three feeding lines in which along the traveling direction of a moving body, electric current of phase difference of 120 degree flows, and an inverter which controls electric current flowing in each of said feeding lines;
Each of feeding lines is arranged so that the N and S poles are alternately generated at every 3 out of a certain number of magnetic poles (‘magnetic pole group’), and the N-S pole pairs generated by each of feeding lines are not overlapped each other.

11. A time division multiple power feeding apparatus that feeds electric power to an electric vehicle using magnetic induction of the present invention which comprises
A power feeding core which has multiple magnetic poles arranged at regular intervals along the traveling direction of a moving body,
A certain number (‘b’) of feeding line pairs in which along the traveling direction of a moving body, electric current flows countercurrent to the traveling direction of a moving body, and an inverter which controls electric current flowing in each of said feeding line pairs in which electric current flows in different time zones;
Each of feeding line pairs is arranged so that the N and S poles are alternately generated at every b magnetic poles.

12. A time division multiple power feeding apparatus as claim 11, wherein said inverter can control the switch corresponding to each feeding line pair so that the N and S poles are generated at the magnetic pole corresponding to the location of a traveling vehicle.

13. A time division multiple power feeding apparatus as claim 12, wherein said magnetic poles are arranged in a line on the feeding line along the traveling direction of a moving body.

14. A time division multiple power feeding apparatus as claim 12, wherein said magnetic poles are arranged on the feeding line along b rows parallel to the traveling direction of a moving body (‘magnetic pole row’), and the magnetic pole row in which said N and S poles are generated may move sequentially from the 1st to the bth magnetic pole row along the traveling of a vehicle.

15. A time division multiple power feeding apparatus as claim 11, wherein for said magnetic poles, the cross section perpendicular to the traveling direction of a moving body may be I-shaped and the width perpendicular to the traveling direction of a moving body may be less than half of the length of the traveling direction of a moving body.

16. A time division multiple power feeding apparatus as claim 11, wherein for said magnetic poles, the cross section viewed from the road may be I-shaped and the width perpendicular to the traveling direction of a moving body may be more than twice of the length of the traveling direction of a moving body.

17. A frequency division multiple power feeding apparatus that feeds electric power to an electric vehicle using magnetic induction of the present invention which comprises
A power feeding core which have multiple magnetic poles arranged at regular intervals along the traveling direction of a moving body,
A certain number (‘c’) of feeding line pairs in which along the traveling direction of a moving body, electric current flows countercurrent to the traveling direction of a moving body, and
An inverter which controls electric current flowing in each of said feeding line pairs in which electric current of different frequency flows;
Each of feeding line pairs is arranged so that the N and S poles are alternately generated at every c magnetic pole and the N-S pole pairs generated by each feeding line pairs are not overlapped each other.

18. A frequency division multiple power feeding apparatus as claim 17, wherein in each of c sequential magnetic poles along the traveling direction of a moving body, the N poles of different frequencies generated by each of feeding line pairs from the 1st to the cth feeding line pair can be sequentially generated, and in each of the next c sequent magnetic poles, the S poles of different frequencies generated by each of feeding line pairs from the 1st to the cth feeding line pair can be sequentially generated.

19. A frequency division multiple power feeding apparatus as claim 18, wherein the magnetic poles composing said c N poles and said c S poles can be arranged in a line along the traveling direction of a moving body.

20. A frequency division multiple power feeding apparatus as claim 18, wherein the magnetic poles composing said c N poles and said S poles can be sequentially arranged along the traveling direction of a moving body on c parallel lines on a feeding line.

21. A frequency division multiple power feeding apparatus as claim 17, wherein for said magnetic poles, the cross section perpendicular to the traveling direction of a moving body may be I-shaped and the width perpendicular to the traveling direction of a moving body may be less than half of the length of the traveling direction of a moving body.

22. A frequency division multiple power feeding apparatus as claim 17, wherein for said magnetic poles, the cross section viewed from the road may be I-shaped and the width perpendicular to the traveling direction of a moving body may be more than twice of the length of the traveling direction of a moving body.

23. A power collecting apparatus which collects electric power from the space division multiple power feeding apparatus which feeds electric power to a moving body using magnetic induction which comprises
A power collecting core which is installed at the bottom of a moving body with space from the power feeding apparatus, and
A power collecting coil which is wound around said power collecting core so that electric current induced by the power feeding apparatus may flow, and the power collecting coil comprises more than two pairs so as to multiple collect electric power.

24. A multiple power collecting apparatus as claim 23, wherein said power feeding apparatus can generate more than two magnetic fields of different phases using phase division multiplexing, and in each of the pairs of said power collecting coil, electric current of different phase can be induced by said magnetic fields.

25. A multiple power collecting apparatus as claim 23, wherein said power feeding apparatus can generate more than two magnetic fields of different frequencies using frequency division multiplexing, and in each of the pairs of said power collecting coil, electric current of different frequency can be induced by said magnetic field.
